(19) United States
(12) Patent Application Publication
(10) Pub. No.: US 2004/0166273 A1
(43) Pub. Date: Aug. 26, 2004

(54) Examination booklet cover

(76) Inventors: Thomas W. Connell, Glasgow (GB); Thomas Sharp Connell, Glasgow (GB)

Correspondence Address: FLESHNER & KIM, LLP, P.O. Box 221200, Chantilly, VA, 20153-1200, US

(21) Appl. No.: 10/372,665

(22) Filed: Feb. 25, 2003

(51) Int. Cl. B32B 9/00

(52) U.S. Cl. 428/40.1; 156/227; 156/252; 156/277; 428/43

(57) ABSTRACT

A sheet of material 2 which can be incorporated into a booklet has an adhesive strip 5, foldable portion 7 and first and second perforated fold 8a and 8b. Information can be entered into the space delimited between the first and second perforated folds 8 and 10 and concealed by removing a protective paper 6 from the adhesive strip 5 and folding the foldable section 7 at perforated folds 8, such that it sticks to the adhesive strip 7 and conceals information in space 9. The perforated folds 8 and 10 delimit and create a detachable strip 11 which can be torn away in order to reveal the information in space 9 when required.

The present invention relates to apparatus for use in situations where information of a confidential nature is required to be completed on a form, paper, questionnaire or the like. Particularly this invention relates to a product and method for concealing information on a form, paper, questionnaire or the like which may have application in examinations, medical records, ballot papers, legal documents, banking or financial documents, salary pay slips and the like. In a particular embodiment, this invention relates to an examination booklet, which is adapted to allow the name of the candidate to be concealed during marking.

Most people at some time in their life will sit an examination. Generally, the standard procedure is to write answers to the exam questions in an official examination script booklet, which is provided at the exam. Such examination booklets are well known to the art and are comprised of a number of sheets of writing paper, stapled into a book, with a cover sheet on which the candidate's personal information can be entered.

Conventionally, prior to starting the examination, it is normal for candidates to enter information about themselves on the front of the examination paper or script, for example their surname, forename, and matriculation number. This allows easy identification of each candidate's examination paper after marking. However, the major problem which arises from the candidate entering their name on the examination script booklet lies in the fact that the Examiner who marks the script may be prejudiced or biased by knowing the identity of the candidate when marking the paper. It will be appreciated that this could pose a potential problem, particularly where marking is carried out internally within an institution such as a school, college or university. Often in these situations the individual marking the paper is also the teacher, lecturer or tutor of the students whose paper they mark. There is therefore a risk that the marker may be prejudiced or biased by their knowledge of the student. Perhaps a greater risk is not that the Examiner will be prejudiced or biased, but that the candidate may have grounds to object to their eventual results on the basis that the marking may have been prejudiced towards them.

Known approaches to overcome this problem have involved providing examination script booklets, which can be folded in such a way to cover the personal details of the candidate entered on to the front of the script. A common method of concealing this information includes using double-sided tape to hold the paper when folded over. It will be appreciated that in many exams the number of candidates may run into hundreds, and as a consequence it is necessary to employ a considerable amount of time in applying sticky tape and folding the completed examination script booklets, to cover the identification of the candidate prior to sending the scripts to the markers. In fact, many institutions actually employ individuals during examination times, specifically for this task. This can delay the length of time in which the candidates have to wait for the examination results.

Another approach which has been used to overcome the problem of markers knowing the identity of the candidate whose paper they are marking, has been to provide examination script booklets having an envelope-type flap which can be moistened by licking then stuck down. However, it will be appreciated that this is not particularly hygienic, especially as many examination papers have to be prepared in such a way prior to marking. There is also a problem when the envelope type flap has to be removed after marking to identify the candidate, as it is common for these flaps to tear and spoil the paper, and even in some cases to obliterate the candidate's name.

In addition, it is relatively easy to tamper wit the above-described methods of hiding the identity of the candidate whose paper is being marked. For example, it is relatively simple to peel off double-sided tape in order to obtain the candidate's information, and then replace the tape thereafter, such that it is not evident that the paper has been tampered with at all.

Thus, there is a need for a system which offers a more efficient and effective method of concealing information entered on the front of an examination script booklet, to allow the examination script booklet to be marked in an unbiased and fair manner by the marker.

The present invention also has application in other situations where it is necessary to enter information on a document, booklet, form, questionnaire or the like, and where it would be desirable to conceal that information. For example, the invention could be used in connection with ballot papers to conceal a voter's choice, or on particularly sensitive parts of a patient's medical records, or on financial or legal documents or papers, or on salary pay slips.

This may be of an advantage if the document is being transported, for example if ballot papers are being transferred from polling stations, or if medical records are being transferred from one practice to another.

It is an object of the present invention to provide a form which is specially adapted to conceal confidential information and which overcomes the problems inherent to the prior art.

According to the present invention, there is provided a sheet of material having an adhesive section, a foldable portion and a first and second perforated fold, wherein the sheet of material can be folded at the first perforated fold such that the foldable portion fixes to the adhesive section, wherein the first and second perforated fold delimit a detachable section of the foldable portion which can be removed after the foldable portion has been fixed to the adhesive section.

Preferably the adhesive section is an adhesive strip.

The sheet of material may be paper.

The sheet of material may be thin cardboard.

The sheet of material may be a plastic.

The sheet of material may be attached to one or more sheets of paper to form a booklet.

The material may form the cover of the booklet.

Alternatively two or more of the sheets of material may be attached to form a booklet. In this embodiment, information may be concealed in all or some of the pages of the booklet.

The booklet may be an examination script booklet.

The sheet of material may be used in relation to medical records, legal documents or papers, or financial documents or papers.

The sheet of material may be used as a ballot paper or salary pay slip.

Typically when the foldable portion is fixed to the adhesive section information on the sheet of material is concealed. The information is revealed by removing the detachable section.

Preferably the detachable section does not fix to the adhesive section when the foldable portion is folded.

Preferably the adhesive section is provided with a protective paper.

The adhesive section may be stereotape or the like.

Preferably the detachable section is removed by tearing the first and second perforated folds.

Preferably the detachable section is a strip.

Optionally the detachable section may be of a different colour to the sheet of material to allow easy identification.

Optionally at least part of the foldable portion or detachable section has cross-hatching or other marking to conceal information on the sheet.

The foldable portion may be of any suitable shape. For example the foldable portion may constitute an edge of the sheet of material. In the preferred embodiment the foldable portion constitutes the vertical leading edge of the sheet of material.

The sheet of material may have more than one foldable portion, adhesive section and perforated fold.

According to a second aspect of the present invention, there is provided a method of using a sheet of material comprising an adhesive section, foldable portion and first and second perforated fold which delimit a detachable section to temporarily conceal confidential information, comprising the steps of:

(a) concealing information on the sheet of material by folding the sheet of material at the first perforated fold such that the foldable portion is fixed to the adhesive section; and

(b) revealing the confidential information by tearing the first and second perforated fold to remove a detachable section of the foldable portion.

According to a third aspect of the present invention, there is provided a method of manufacturing a sheet of material in accordance with the first aspect of the present invention comprising the steps of:

(a) feeding a reel of material through a press;

(b) printing required text or graphics on the paper;

(c) applying an adhesive strip

(d) perforating the material; and

(e) sheeting the reel of material into individual sheets.

Preferably the material is paper.

An embodiment of the present invention will now be described, by way of example only, with reference to the following drawing of which:

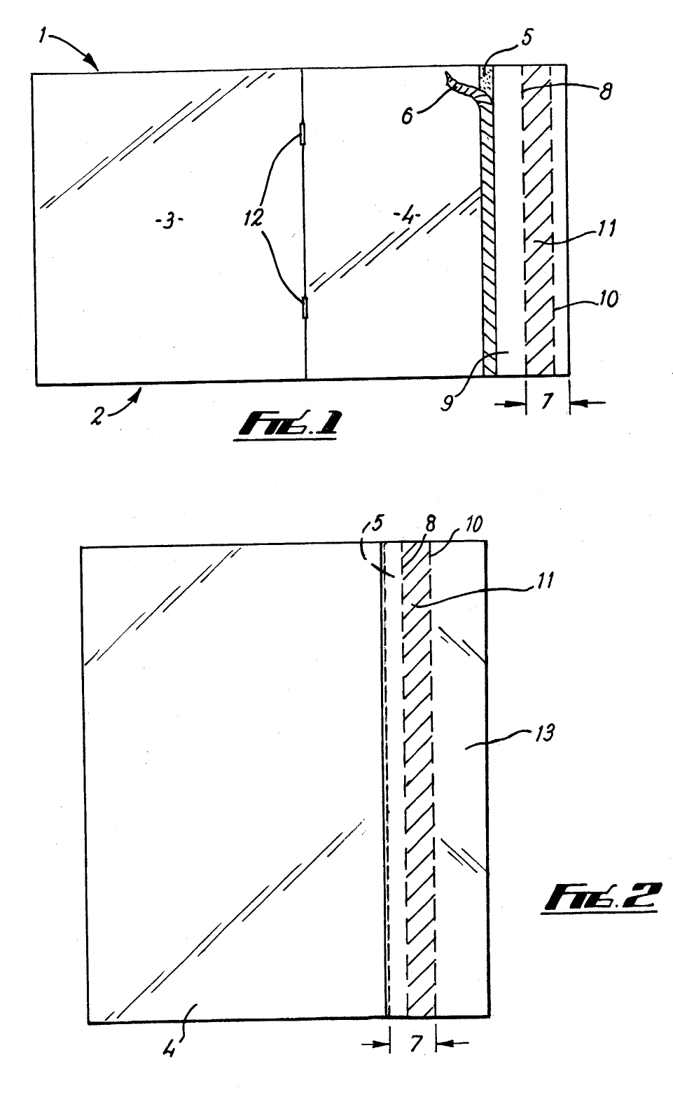

FIG. 1 illustrates an elevation of one embodiment of the present invention, being an open booklet cover prior to folding in accordance with the present invention;

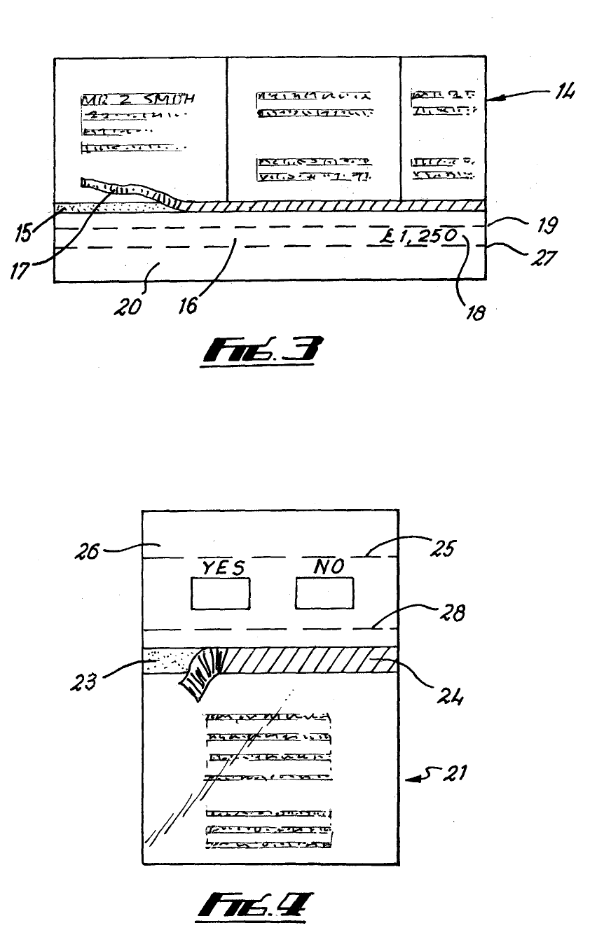

FIG. 2 illustrates a front elevation of a booklet cover folded to conceal information;

FIG. 3 shows an alternative embodiment of the present invention, being a pay slip;

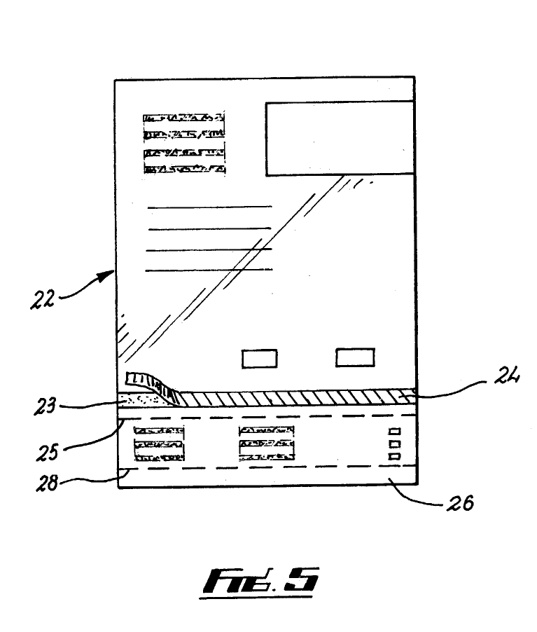

FIG. 4 shows an alternative embodiment of the present invention, being a ballot paper; and

FIG. 5 shows an alternative embodiment of the present invention, being a medical document.

Referring to FIG. 1, an embodiment of the present invention is generally depicted at,1 as an examination script booklet. The booklet is comprised of a number of sheets of paper (not shown) in which the candidate can write their answers to the examination, and a cover sheet 2, having a back 3 and front 4. The cover sheet 2 is typically stapled together and over the sheets of paper by staples 12. The front 4 of the cover sheet 2 of the examination script booklet 1 has an adhesive strip 5, which runs in a vertical direction and is provided with a removable protective paper 6 which covers the adhesive strip 5. The protective paper 6 is typically torn away to reveal the adhesive strip. The front 4 of the booklet 1 further comprises a foldable section 7, which is defined by perforated fold 8 (shown by dotted lines).

The front 4 of the booklet 1 typically contains instructions to the candidate and space for entering non-sensitive information such as date, desk number and the title of the exam paper. Space for entering the forename and surname of the candidateis provided at 9 between the adhesive strip 5 and the perforated fold 8. The foldable section 7 can be folded back at perforated fold 8 to cover the candidate's name at 9.

In use the examination candidate will fill in their name in the space provided 9, and other details such as date and exam name in the main section at the front 4 of the booklet 1. In order to conceal their identity prior to handing in the examination booklet for marking, the protective paper 6 is removed from the adhesive strip 5 and the foldable section 7 is folded at perforated fold B. Typically at least part of the foldable section 7 or detachable section will have cross-hatching or other marking to help conceal the information on the sheet. The foldable section 7 sticks to the adhesive strip 5. The candidate's name will thereafter be covered by the foldable section 7, which will be held fast by the adhesive strip 5. The examination script booklet can then be marked without the risk of the marker knowing the identity of the candidate whose paper he or she is marking, thereby eliminating any risk of prejudice or bias towards the candidate.

The foldable section is defined by, and is folded to cover the confidential information at perforated fold. Referring to FIG. 2, which shows an alternative embodiment of an examination script, the foldable section comprises a second perforated fold 10 (shown by dotted lines). The two perforated folds a and 10 delimit and create a detachable strip 11. In order to reveal the name of the candidate after the script has been marked, detachable strip 11 can be torn way by virtue of perforated folds 8 and 10. The detachable strip may be of a different colour or shaded to enable easy identification of the portion of the foldable section, which can be removed. On tearing the perforated folds 8 and 10 the strip 11 can be removed thereby revealing the candidate name which was previously obscured by foldable section 7. It will be appreciated that as only shaded section A is fixed to the adhesive strip 5, detachable strip 11 is not fixed and can be removed without tearing or spoiling the paper underneath which has the candidate's name. The sheets of paper containing the candidate's answers and stapled into the cover sheet to create the booklet are visible at 13.

The present invention can also have other applications. For example, there may be provided a pay slip 14 (FIG. 3) having an adhesive strip 15 which is provided with a removable, tear away section 16 and protective paper 17 which covers the adhesive strip 15. Confidential salary details can be entered into the space at 18, between adhesive strip 15 and perforated fold 19. The foldable section 20 can be folded back at perforated fold 19 and will fix to the adhesive strip 15 once the protective 17 is removed to cover this confidential information. In order to reveal the confidential details, for example when the employee receives his or hex pay slip, the detachable section 16 can be removed by tearing perforated folds 19 and 27. By tearing away the detachable section the details entered in space 18 are revealed.

Example embodiments of a ballot paper 21 and medical document 22 are shown in FIGS. 4 and 5, each having an adhesive strip 23 with a removable protective paper 24, perforated folds 25 and 28 and foldable section 26. If more than one area of the document or paper is to be concealed, the document or paper may have a plurality of adhesive strips, protective papers, perforated folds and foldable sections.

The present invention may also be used in financial and legal documents and the like. For example, the invention may be used on bank statements.

In the preferred embodiments, the sheet of material is paper. However, it is recognised that a flexible cardboard material or even a plastic may be used.

The advantage of the present invention lies in the fact that confidential information can be hidden by folding back the foldable section of the one-piece sheet of paper on to the adhesive section (which may be an adhesive strip). For example, in the case of the examination script booklet shown in FIG. 1, the name of the candidate can be hidden. In this example the need to use an external sticking source, such as double sided sticking tape is eliminated and the length of time taken to prepare the scripts for marking is minimised. Furthermore as the procedure is relatively simple and quick to perform, the candidate can be instructed to conceal his or her name prior to handing in the booklet at the end of the exam. As the foldable section, which covers the candidate's name, will be stuck fast to the adhesive strip, it is easy to identify any booklet, which has been tampered with.

The present invention has a further advantage in that it can be easily manufactured in one procedure. The one-piece sheet of paper can be manufactured by feeding reels of paper into a press. Text or graphics can be printed onto the paper, following which an adhesive strip can be applied to the front of the sheet in one continuous cyclic motion. A sheeter can be used in conjunction to create perforations on the folds which enable the detachable strip to be removed after marking of the script. The reel of paper can then be “sheeted” into individual sheets.

A further advantage of the present invention is that it provides a simple to use method of hiding sensitive information such as an examination candidate's name, medical information, salary details, voting choice or the like This eliminates the need for what are often costly and timely procedures, required to conceal this information in conventional examination booklets, ballot papers, medical records, pay slips and the like.

Further modifications and improvements may be incorporated without departing from the scope of the invention herein intended.

1. A sheet of material having an adhesive section, a foldable portion and a first and second perforated fold, wherein the sheet of paper can be folded at the first perforated fold, such that the foldable portion fixes to the adhesive section, wherein the first and second perforated fold delimit a detachable section of the foldable portion which can be removed after the foldable portion has been fixed to the adhesive section.

2. A sheet of material as claimed in claim 1 wherein the material is paper, cardboard or plastic.

3. A sheet of material as claimed in claim 1 wherein the adhesive section is an adhesive strip.

4. A sheet of material as claimed in claim 1, wherein, fixing of the foldable portion to the adhesive section conceals information on the sheet of material.

5. A sheet of material as claimed in claim 1, wherein information concealed by the foldable portion is revealed by removing the detachable strip.

6. A sheet of material as claimed in claim 1, wherein the detachable strip is removed by tearing the first and second perforated fold.

7. A sheet of material as claimed in claim 1, wherein the detachable strip does not fix to the adhesive section when the foldable portion is folded.

8. A sheet of material as claimed in claim 1, wherein the adhesive section is provided with a protective paper.

9. A sheet of material as claimed in claim 1, wherein the adhesive section is stereotape.

10. A sheet of material as claimed in claim 1, wherein at least part of the detachable strip or foldable portion is of a different colour to the sheet of material or has cross-hatching or other markings to allow easy identification and concealment of the information.

11. A sheet of material as claimed in claim 1, wherein the foldable portion constitutes an edge of the sheet of material.

12. A sheet of material as claimed in claim 1, being attached to one or more sheets of paper to form a booklet.

13. A booklet as claimed in claim 12, wherein the sheet of material forms the booklet cover.

14. A booklet as claimed in claim 12, being an examination script booklet.

15. A sheet of material as claimed in claim 1 for use in medical records, or legal or financial documents or papers.

16. A sheet of material as claimed in claims 1 for use as a ballot paper or a salary pay slip.

17. A method of using a sheet of material comprising an adhesive section, foldable portion and first and second perforated fold which delimit a detachable section, to temporarily conceal information on the sheet of material, comprising the steps of:
(a) concealing information on the sheet of material by folding the sheet of material at the first perforated fold, such that the foldable portion is fixed to the adhesive section; and
(b) revealing the information by tearing the first and second perforated fold to remove the detachable section of the foldable portion.

18. A method of manufacturing a sheet of material comprising an adhesive strip, foldable portion and first and second perforated folds which can be used to conceal information, comprising the steps of:
(a) feeding a reel of paper through a press;
(b) printing required typographics on the paper;
(c) applying an adhesive strip;
(d) perforating the paper; and
(e) sheeting the reel of paper into individual sheets.
